(19) United States
(12) Patent Application Publication
(10) Pub. No.: US 2010/0082708 A1
(43) Pub. Date: Apr. 1, 2010

(54) System and Method for Management of Performance Fault Using Statistical Analysis

(75) Inventors: Byung Seop Kim, Anyang-si (KR); Chi Hoon Lee, Suwon-si (KR); Jae Hee Park, Busan (KR); Jeong Ho Shin, Seoul (KR); Chi Hoon Park, Yongin-si (KR); Jong Sun Kim, Seongnam-si (KR); Sung Hwa Ryu, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: SAMSUNG SDS CO., LTD., Seoul (KR)

(21) Appl. No.: 12/514,928

(22) PCT Filed: Apr. 11, 2007
(86) PCT No.: PCT/KR2007/001753

§ 371 Date: Nov. 2, 2009

(30) Foreign Application Priority Data
Nov. 16, 2006 (KR) 10-2006-0113444

(51) Int. Cl. G06F 17/18; G06F 17/30; G06F 11/00

(52) U.S. Cl. 707/812; 702/179; 707/E17.044; 714/1; 714/E11.001

(57) ABSTRACT

A system includes: at least one managed resource having an agent for collecting and transmitting performance information; an integrated management server for receiving the information and managing it in an integrated manner; a statistical information generating module for extracting previously set performance items and automatically generating statistical information for each performance item; and a fault management server for receiving the information from the integrated management server in real time, performing statistical analysis on current performance information, comparing the analysis results with the information generated by the statistical information generating module to determine whether a fault is likely to occur, generating a fault event according to the determination result, and transmitting the fault event to the integrated management server.

### TECHNICAL FIELD

The present invention relates to a system and method for managing a performance fault, and more particularly, to a system and method for managing a performance fault using statistical analysis which are capable of minimizing the occurrence of performance faults in operation and removing causes of performance faults by receiving, in real time, performance information of managed resources for providing information technology (IT) service, detecting performance faults in advance through the statistical analysis of the performance information, and notifying a user of a fault.

### BACKGROUND ART

In general, information technology (IT) management collectively refers to network management, system management, application management, and database (DB) management.

In conventional IT management, performance information is collected from a managed object, and when a value of the collected performance information exceeds a threshold of the performance information or a fault tolerance value previously set by a user, occurrence of a fault is reported.

This conventional technique has the following problems.

First, even though systems utilizing IT infrastructures (e.g., a server, a network, a database, and the like) or applications differ in capacity and load, a user must manually perform analysis on individual items based on past data, and manually set a suitable threshold (which differs from system to system), consuming a considerable amount of M/H in system operation.

Second, the determination as to whether a fault occurs is based on only the threshold and the fault tolerance range of the collected performance information. Accordingly, when a performance value at a specific time is higher than an average, even a normal system may be judged as being faulty.

Third, when a value collected for a predetermined time from a system having a normal performance information value of about 50% is between 10% and 20%, the system is faulty. However, since the value is not out of the threshold range according to an existing fault criterion, the system is erroneously judged to be normal. This may cause a system error.

Thus, since the conventional IT management system is a simple system that collects the performance value and reports fault occurrence when the collected value exceeds a predetermined threshold, it is incapable of detecting a fault in advance. Also, the system reports even a momentary threshold excess, which is not problematic in the IT infrastructure and application, as a fault. Further, the system is incapable of analyzing causes of faults and system performance.

### DISCLOSURE OF INVENTION

### Technical Problem

It is an object of the present invention to provide a system and method for managing a performance fault using statistical analysis, which are capable of predicting, in advance, performance faults of managed resources for providing information technology (IT) service and providing more stable IT service through minimized performance-fault misdetection, by receiving performance information of the managed resources and managing the performance fault through statistical analysis in real time.

### Technical Solution

According to a first aspect of the present invention, there is provided a system for managing a performance fault using statistical analysis, the system comprising: at least one managed resource having an agent for collecting performance information of the managed resource and transmitting the performance information; an integrated management server for receiving the performance information from the managed resource and managing the performance information in an integrated manner; a statistical information generating module for extracting previously set performance items to be analyzed from the performance information managed by the integrated management server, and automatically generating statistical information for each performance item; and a fault management server for receiving the performance information from the integrated management server in real time, performing statistical analysis on the current performance information, comparing the analysis results with the statistical information generated by the statistical information generating module to determine whether a fault is likely to occur, generating a fault event according to the determination result, and transmitting the fault event to the integrated management server.

The managed resource may comprise at least one of a server/hardware, a network, a database (DB), and an application for providing information technology (IT) service.

The statistical information may comprise at least one of a management limit, an average, and a standard deviation.

The statistical analysis may be performed in real time according to a statistical process control chart previously set for each performance item.

The statistical process control chart may be at least one of an Xbar-R control chart, an Xbar-S control chart, an I-MR control chart, a C control chart, and a U control chart.

The fault management server may receive the performance information from the integrated management server in real time, store the performance information in a separate performance information database, and perform the statistical analysis on the performance information stored in the performance information database when required.

The fault management server may further comprise a performance information database for receiving the performance information from the integrated management server in real time, and storing and managing the performance information, and the statistical information generating module may periodically extract previously set performance items to be analyzed from the performance information stored in the performance information database and automatically generate statistical information for each performance item.

The integrated management server may further comprise a fault management database for storing and managing information on the performance fault of each managed resource, and the fault management server may transmit the generated fault event to the fault management database.

The fault management server may further comprise a fault management console for visually notifying a user of results of statistical analysis of the current performance information and the generated fault event in real time.

The fault management server may further analyze a pattern of the current performance information using a 7-rule fault prediction scheme to determine whether a fault is likely to occur, and generate the fault event when it is determined that the fault is likely to occur.

The fault management server may further comprise a fault event database for storing and managing the generated fault event.

According to a second aspect of the present invention, there is provided a method for managing a performance fault using statistical analysis in a system comprising at least one managed resource for providing information technology (IT) service, an integrated management server for managing the managed resources in an integrated manner, and a fault management server for monitoring a fault occurring at the managed resource, the method comprising the steps of: (a) collecting the performance information from the managed resource and transmitting the collected performance information to the integrated management server; (b) transmitting, by the integrated management server, the collected performance information to the fault management server in real time; (c) performing, by the fault management server, the statistical analysis on the received current performance information, comparing the analysis results with previously set statistical information to determine whether a fault is likely to occur; and (d) when it is determined that the fault is likely to occur, generating a fault event and transmitting it to the integrated management server.

The statistical information in step (c) may comprise at least one of a management limit, an average, and a standard deviation.

The statistical analysis in step (c) may be performed in real time according to a statistical process control chart previously set for each performance item.

The statistical process control chart may be at least one of an Xbar-R control chart, an Xbar-S control chart, an I-MR control chart, a C control chart, and a U control chart.

Step (c) may comprise the step of storing the received performance information in a separate performance information database, and performing the statistical analysis on the performance information stored in the performance information database when required.

The statistical information in step (c) may be automatically generated for each performance item after receiving the performance information in real time, storing the performance information in the performance information database, and periodically extracting previously set performance items to be analyzed from the performance information stored in the performance information database.

Step (c) may comprise the step of further analyzing a pattern of the current performance information using a 7-rule fault prediction scheme to determine whether a fault is likely to occur, and generating a fault event when it is determined that the fault is likely to occur.

The fault event generated in step (d) may be transmitted to a fault management database associated with the integrated management server.

The fault event generated in step (d) may be stored and managed in a fault event database associated with the fault management server.

Steps (c) and (d) may comprise the step of visually notifying a user of results of statistical analysis of the current performance information and the generated fault event in real time.

According to a third aspect of the present invention, there is provided a recording medium having a program recorded thereon for executing the method for managing a performance fault using statistical analysis.

### ADVANTAGEOUS EFFECTS

According to a system and method for managing a performance fault using statistical analysis of the present invention, a performance fault of managed resources for providing the IT service can be predicted in advance and information technology service can be provided through minimized performance-fault misdetection by receiving performance information of managed resources and managing a performance fault through statistical analysis in real time.

According to the present invention, the application of SPC scheme to the management of the system or application yields the following advantages. First, a management limit (threshold) for management items can be automatically set. In other words, the management limit (threshold) is applied for easy automatic monitoring based on past statistical data without the user needing to separately set the management limit by individually checking each performance index and manually designating the management limit.

Second, a fault can be prevented in advance. With the goal of a fault-free operating environment, faults can be detected in advance by applying the management limit (threshold) and the pattern (7-rule) specific to the server or application using the statistical value computed based on the past performance index of the server or application.

Third, fault misdetection can be minimized. Faults are detected using the average value and the distribution of the partial group, instead of using an individual performance value. Since data is not distorted by a large, momentary variation, mis-detection can be minimized.

Fourth, the method assists in redistributing system resources through a comparison of resource capacity. The method provides a basis so that the user expands or redistributes system resources in consideration of uneven distribution and idleness of the resources by simultaneously checking/analyzing a usage amount of a central processing unit (CPU) and a memory of several servers.

### BRIEF DESCRIPTION OF THE DRAWINGS

FIG. 1 is a schematic block diagram illustrating a system for managing a performance fault using statistical analysis according to an exemplary embodiment of the present invention;

FIG. 2 is a flowchart illustrating a method for managing a performance fault using statistical analysis according to an exemplary embodiment of the present invention; and

FIG. 3 is a conceptual diagram illustrating a method for processing data in real time according to an exemplary embodiment of the present invention.

### MODE FOR THE INVENTION

Hereinafter, exemplary embodiments of the present invention will be described in detail. However, the present invention is not limited to the exemplary embodiments disclosed below, but can be implemented in various modified forms. The present exemplary embodiments are provided to fully enable those of ordinary skill in the art to embody and practice the invention.

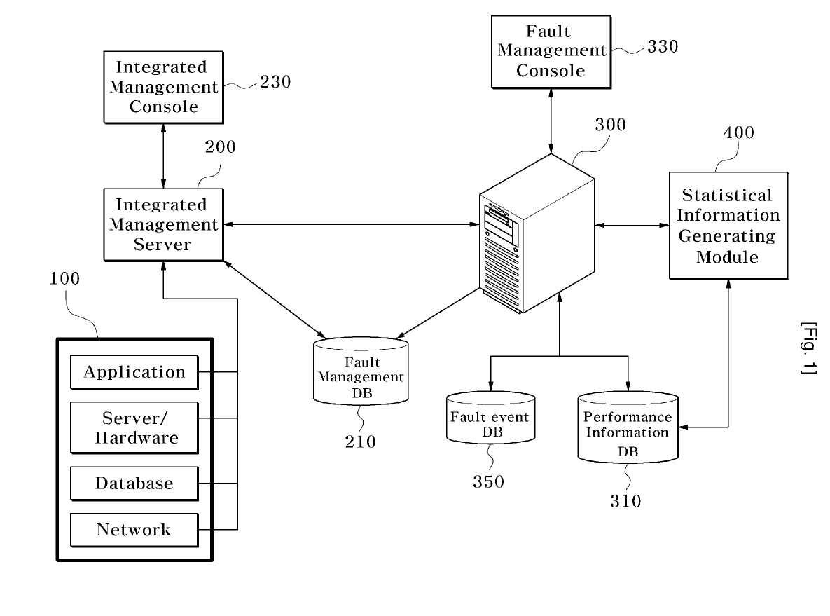

FIG. 1 is a schematic block diagram illustrating a system for managing a performance fault using statistical analysis according to an exemplary embodiment of the present invention.

Referring to FIG. 1, a system for managing a performance fault using statistical analysis according to an exemplary embodiment of the present invention comprises at least one managed resource 100, an integrated management server 200, a fault management server 300, and a statistical information generating module 400.

The managed resource 100 may include an information technology (IT) infrastructure, such as server/hardware, networks, and databases (DBs), an application for providing service based on the information technology infrastructure, and the like.

Each agent of the managed resource 100 collects performance information data in a predetermined period and transmits it to the integrated management server 200.

Meanwhile, any of the agents may collect the performance information, determine a management limit (i.e., threshold) and a fault tolerance range, and then transmit the performance information to the integrated management server 200.

The integrated management server 200 is a server for managing the performance information of the managed resource 100 in an integrated manner. The integrated management server 200 transmits the performance information to the fault management server 300 in real time.

The integrated management server 200 may be implemented by a typical integration control solution used in large offices, such as Enterprise Management System (EMS), System Management System/Software/Service (SMS), Network Management System (NMS), Application Management System (AMS), Facility Management System (FMS), and the like.

Preferably, the integrated management server 200 transmits the performance information from the managed resource 100 to the fault management server 300 in real time. However, the present invention is not limited to such a configuration. Alternatively, the fault management server 300 may directly take the performance information in real time by accessing a data source of the integrated management server 200.

The integrated management server 200 may further comprise a fault management database (DB) 210 for storing and managing information on a performance fault of the managed resource 100.

The integrated management server 200 may further comprise an integrated management console 230 for visually notifying a manager of integrated management information (e.g., real-time performance information) and performance fault states for the managed resource 100.

The fault management server 300 monitors, in real time, performance information data managed by the integrated management server 200, performs statistical analysis to detect performance faults, and removes meaningless performance faults that momentarily exceed a management limit (threshold). The fault management server 300 analyzes a pattern of the managed resource 100 and notifies a user of the likelihood of performance faults in real time.

That is, the fault management server 300 receives the performance information managed by the integrated management server 200 in real time, performs the statistical analysis on current performance information, compares the analysis results with statistical information generated by the statistical information generating module 400 to generate a fault event, and transmits the fault event to the integrated management server 200.

Preferably, the statistical analysis is performed in real time according to a previously set statistical process control chart for each performance item.

Examples of the statistical process control chart may include an Xbar-R control chart, an Xbar-S control chart, an 1-MR control chart, a C control chart, a U control chart, and the like.

Normally, statistical process control (SPC) is for enhancing the process, and uses statistics to understand the process. SPC is a management scheme for maintaining any process in a stable state using data by reducing variation of the process.

SPC, one strategy for enhancing quality and productivity, is aimed at minimizing a process distribution around a target value by understanding and managing the process distribution using statistics. Using SPC, data is collected from a process, statistical quantities such as an average value and a range are computed and marked on a control chart which is used to understand the process distribution, in order to estimate process information (e.g., average, variation, error rate, and the like) and determine process capability.

Here, the “control chart” was proposed by Dr. Walter Shewhart in 1924 and is used to suppress the occurrence of bad goods in advance by continuously controlling a process and rapidly taking countermeasures when the process becomes abnormal.

Meanwhile, SPC scheme has a variety of applications, such as the performance or features of facilities, the transport time of a distribution control system, profit/sale in a financial accounting fields, software (S/W) development, as well as applications for manufacturing places. Detailed descriptions of these applications will be omitted.

The fault management server 300 may further comprise a performance information database (DB) 310 for receiving, storing and managing the managed performance information from the integrated management server 200 in real time. The fault management server 300 may enable a user to access a history of faults from the performance information DB 310 and may perform the statistical analysis on the performance information stored in the performance information DB 310.

Preferably, the fault management server 300 transmits a generated fault event to the fault management database 210 of the integrated management server 200.

The fault management server 300 may further comprise a fault management console 330 for visually providing results of statistical analysis of current performance information and the generated fault event to the user in real time.

The fault management server 300 may further analyze a pattern of the current performance information using a typical 7-rule fault prediction scheme and generate a fault event when the fault is likely to occur based on analysis results.

The fault management server 300 may further comprise a fault event database (DB) 350 for storing and managing the generated fault event. The user may obtain a history of faults from the fault event DB 350.

The statistical information generating module 400 extracts analyzed performance items previously set by the user from the performance information managed by the integrated management server 200, and automatically generates statistical information for each performance item. Preferably, the statistical information generating module 400 operates periodically at a specific time every day.

In other words, the statistical information generating module 400 periodically extracts the previously set analyzed performance items from the performance information stored in the performance information DB 310 of the fault management server 300, and automatically generates statistical information for each performance item.

Here, examples of the statistical information may include management limit (threshold), average, standard deviation, or the like.

The extraction period and the processed data amount are set for each control chart by the user using the fault management console 330 in advance. Examples of the set information may include a control chart (e.g., an Xbar-R control chart, an Xbar-S control chart, an I-MR control chart, a C control chart, a U control chart, etc.) to be applied to one set of performance information, a size of a partial group (1 to 25), a management-limit change period (day), a minimum number of applied partial groups, a minimum number of applied data, an SPEC designating scheme, an SPC computation scheme, a range type, a fault tolerance range, a 7-rule, etc.

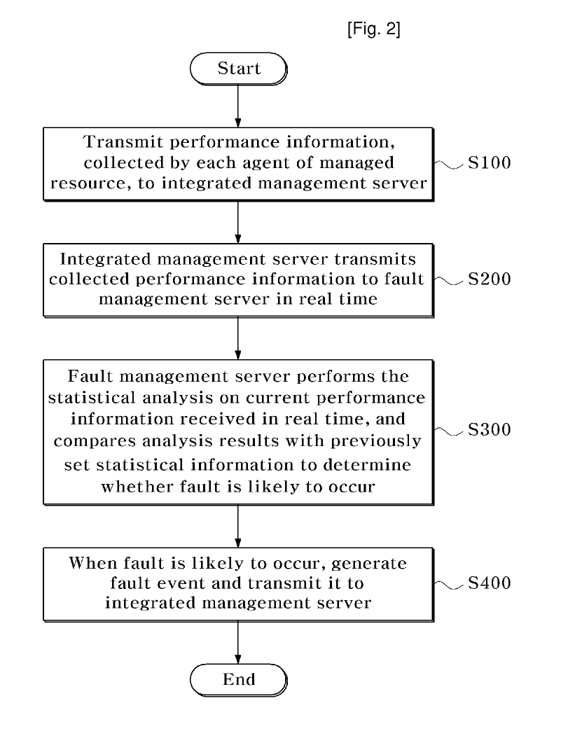

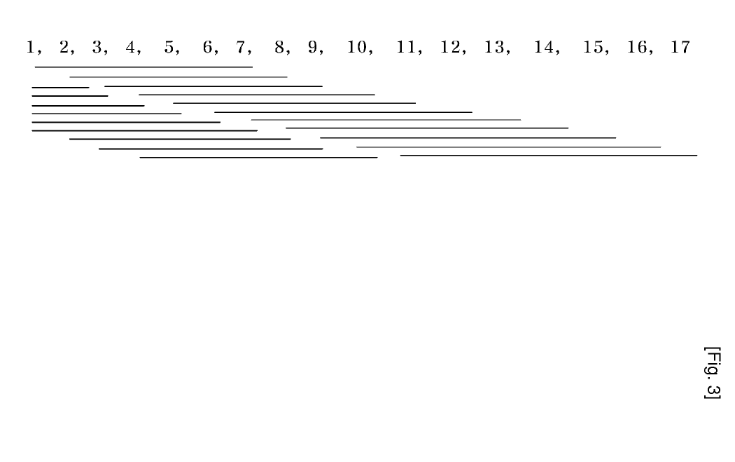

FIG. 2 is a flowchart illustrating a method for managing a performance fault using statistical analysis according to an exemplary embodiment of the present invention, and FIG. 3 is a conceptual diagram illustrating a method for processing data in real time according to an exemplary embodiment of the present invention.

Referring to FIGS. 2 and 3, first, each agent of the managed resource 100 (see FIG. 1) transmits performance information data collected in a predetermined period to the integrated management server 200 (see FIG. 1) (S100).

The integrated management server 200 then transmits the performance information data from each agent of the managed resource 100 to the fault management server 300 in real time (S200).

The fault management server 300 processes seven 5-partial groups in order to perform statistical processing on the performance information data received in real time, as shown in FIG. 3.

Specifically, a serial number of 1 to 17 indicates an order of data input, solid lines indicate groups of data, and downward movement of the solid lines indicates movement of the data according to the order.

First, the process waits until all performance information data of the partial group is input. When the seventh data of the partial group is input, one statistical process control (SPC) computation and pattern analysis scheme, i.e., the 7-rule scheme, is applied to the current partial group (1˜7). When the eighth data is input, 2 to 8 become the current partial group. Since the size of the past partial group (1) is 1, only the current partial group (2˜8) is subject to a computation and the past partial group (1) is not subject to the computation.

When the ninth data is input, 3 to 9 become the current partial group. Since the size of the past partial group (1˜2) is greater than 1, the partial group (3˜9) and the past partial group (1˜2) are both subject to the computation.

Finally, when the fourteenth data is input, 8 to 14 become the current partial group.

Since the size of the past partial group (1˜7) is greater than 1, the current partial group (8˜14) and the past partial group (1˜7) are both subject to the computation.

In this case, the computed value for the past partial group (1˜7) becomes equal to that for the first current partial group (1˜7). As a result, whenever new data is input, the partial group is processed in real time on the basis of the new data, using the past data numbering one less than the partial groups.

The fault management server 300 then performs the statistical analysis on the current performance information data received in real time in step S200, and compares the analysis results with the previously set statistical information (e.g., a management limit, an average, a standard deviation, etc.) to determine whether a fault is likely to occur (S300). When it is determined that the fault is likely to occur, the fault management server 300 generates a fault event and transmits it to the integrated management server 200 (S400).

Here, the statistical analysis is performed in real time using a statistical process control chart (e.g., an Xbar-R control chart, an Xbar-S control chart, an I-MR control chart, a C control chart, a U control chart, or the like) that is previously set for each performance item.

In step S300, the performance information data provided in real time may be stored in the separate performance information DB 310 (see FIG. 1), and the statistical analysis may be performed on the performance information data stored in the performance information database DB 310.

Preferably, the statistical information in step S300 is automatically generated for each performance item previously set as an analyzed performance item by the user and periodically extracted from the performance information data stored in the performance information DB 310.

Preferably, the fault management server 300 further analyzes the pattern of the current performance information data using a typical 7-rule fault prediction scheme to determine whether a fault is likely to occur in step S300, and generates the fault event when it is determined that a fault is likely to occur.

Preferably, the fault event generated in step S400 is sent to the fault management DB 210 (see FIG. 1) associated with the integrated management server 200.

Preferably, the fault event generated in step S400 is stored and managed in the fault event DB 350 (see FIG. 1) associated with the fault management server 300.

In steps S300 and S400, the result of the statistical analysis of the current performance information and the generated fault event may be visually notified to the user via the fault management console 330 (see FIG. 1) in real time.

In the present invention, the fault can be detected in advance using the statistical process control (SPC) prediction scheme, i.e., the 7-rule scheme, the managed item data can be stored, the pattern of the item data that is the same as defined by the 7-rule scheme can be judged as a sign of a fault, and the user can determine the likelihood of fault occurrence based on the sign and take measures prior to the fault occurrence, as described above.

Furthermore, in the present invention, the statistical process control (SPC) chart, such as an Xbar-R, an Xbar-S, an I-MR, a C control chart or a U control chart, is computed in real time, and the computed result is provided to the user visually, e.g., in graphical form, so that the user can view the analysis results of digital and analog data in real time to enhance the process.

For example, in the case of a system, a server for providing online service for 24 hours×365 days, not an occasional server, or equipment for controlling manufacturing facilities that work without a break, will always use some system resources equally without deviation due to time difference.

As a usage value for a central processing unit (CPU) and a memory of the system is managed through SPC, the fault can be prevented in advance by immediately checking abnormal use of such system resources.

In the case of an application, a fault can be prevented in advance by applying SPC to items, such as a response time, the number of processed cases, and the number of errors, of an online process, transaction or webpage operating for 24 hours.

Meanwhile, the method for managing a performance fault using statistical analysis according to the exemplary embodiment of the present invention may be implemented as a computer code on a computer-readable recording medium. The computer-readable recording medium may be any recording medium capable of storing computer-readable data.

Examples of the computer-readable recording medium include a read only memory (ROM), a random access memory (RAM), a compact disk-read only memory (CD-ROM), a magnetic tape, a hard disk, a floppy disk, a mobile storage, a flash memory, an optical data storage, etc. Furthermore, the computer-readable recording medium may be carrier waves, e.g., transmission over the Internet.

The computer-readable recording medium may be distributed among computer systems connected to a network so that the method is stored and executed as distributed segments of code.

While the invention has been shown and described with reference to certain exemplary embodiments thereof, it will be understood by those skilled in the art that various changes in form and details may be made therein without departing from the spirit and scope of the invention as defined by the appended claims.

1. A system for managing a performance fault using statistical analysis, the system comprising:
at least one managed resource having an agent for collecting performance information of the managed resource and transmitting the performance information;
an integrated management server for receiving the performance information from the managed resource and managing the performance information in an integrated manner;
a statistical information generating module for extracting previously set performance items to be analyzed from the performance information managed by the integrated management server, and automatically generating statistical information for each performance item; and
a fault management server for receiving the performance information from the integrated management server in real time, performing statistical analysis on the current performance information, comparing the analysis results with the statistical information generated by the statistical information generating module to determine whether a fault is likely to occur, generating a fault event according to the determination result, and transmitting the fault event to the integrated management server.

2. The system according to claim 1, wherein the managed resource comprises at least one of a server/hardware, a network, a database (DB), and an application for providing information technology (IT) service.

3. The system according to claim 1, wherein the statistical information comprises at least one of a management limit, an average, and a standard deviation.

4. The system according to claim 1, wherein the statistical analysis is performed in real time according to a statistical process control chart previously set for each performance item.

5. The system according to claim 4, wherein the statistical process control chart is at least one of an Xbar-R control chart, an Xbar-S control chart, an I-MR control chart, a C control chart, and a U control chart.

6. The system according to claim 1, wherein the fault management server receives the performance information from the integrated management server in real time, stores the performance information in a separate performance information database, and performs the statistical analysis on the performance information stored in the performance information database when required.

7. The system according to claim 1, wherein the fault management server further comprises a performance information database for receiving the performance information from the integrated management server in real time, and storing and managing the performance information, and
the statistical information generating module periodically extracts previously set performance items to be analyzed from the performance information stored in the performance information database and automatically generates statistical information for each performance item.

8. The system according to claim 1, wherein the integrated management server further comprises a fault management database for storing and managing information on the performance fault of each managed resource, and the fault management server transmits the generated fault event to the fault management database.

9. The system according to claim 1, wherein the fault management server further comprises a fault management console for visually notifying a user of results of statistical analysis of the current performance information and the generated fault event in real time.

10. The system according to claim 1, wherein the fault management server further analyzes a pattern of the current performance information using a 7-rule fault prediction scheme to determine whether a fault is likely to occur, and generates the fault event when it is determined that the fault is likely to occur.

11. The system according to claim 1, wherein the fault management server further comprises a fault event database for storing and managing the generated fault event.

12. A method for managing a performance fault using statistical analysis in a system comprising at least one managed resource for providing information technology (IT) service, an integrated management server for managing the managed resources in an integrated manner, and a fault management server for monitoring a fault occurring at the managed resource, the method comprising the steps of:
(a) collecting the performance information from the managed resource and transmitting the collected performance information to the integrated management server;
(b) transmitting, by the integrated management server, the collected performance information to the fault management server in real time;
(c) performing, by the fault management server, the statistical analysis on the received current performance information, comparing the analysis results with previously set statistical information to determine whether a fault is likely to occur; and
(d) when it is determined that the fault is likely to occur, generating a fault event and transmitting it to the integrated management server.

13. The method according to claim 12, wherein the statistical information in step (C) comprises at least one of a management limit, an average, and a standard deviation.

14. The method according to claim 12, wherein the statistical analysis in step (C) is performed in real time according to a statistical process control chart previously set for each performance item.

15. The method according to claim 14, wherein the statistical process control chart is at least one of an Xbar-R control chart, an Xbar-S control chart, an I-MR control chart, a C control chart, and a U control chart.

16. The method according to claim 12, wherein step (c) comprises the step of storing the received performance information in a separate performance information database, and performing the statistical analysis on the performance information stored in the performance information database when required.

17. The method according to claim 12, wherein the statistical information in step (c) is automatically generated for each performance item after receiving the performance information in real time, storing the performance information in the performance information database, and periodically extracting previously set performance items to be analyzed from the performance information stored in the performance information database.

18. The method according to claim 12, wherein step (c) comprises the step of further analyzing a pattern of the current performance information using a 7-rule fault prediction scheme to determine whether a fault is likely to occur, and generating a fault event when it is determined that the fault is likely to occur.

19. The method according to claim 12, wherein the fault event generated in step (d) is transmitted to a fault management database associated with the integrated management server.

20. The method according to claim 12, wherein the fault event generated in step (d) is stored and managed in a fault event database associated with the fault management server.

21. The method according to claim 12, wherein steps (c) and (d) comprise the step of visually notifying a user of results of statistical analysis of the current performance information and the generated fault event in real time.

22. A computer-readable recording medium having a program recorded thereon for executing the method according to claim 12 on a computer.
